(19) United States
(12) Patent Application Publication
(10) Pub. No.: US 2009/0144245 A1
(43) Pub. Date: Jun. 4, 2009

(54) Managing indicator values

(76) Inventors: Karl-Peter Nos, Rauenberg-Malschenberg (DE); Gerald Krause, Lorsch (DE)

Correspondence Address: FISH & RICHARDSON, P.C., PO BOX 1022, MINNEAPOLIS, MN, 55440-1022, US

(21) Appl. No.: 11/999,420

(22) Filed: Dec. 4, 2007

(51) Int. Cl. G06F 17/30

(52) U.S. Cl. 707/3; 707/100; 707/E17.014; 707/E17.044

(57) ABSTRACT

Among other disclosed subject matter, a computer-implemented method for managing indicator values includes identifying a change that has been made in a data source to a data value relating to a specific date. Multiple indicators have been defined that can be evaluated using business information in the data source. The method includes identifying, in a history repository that is separate from the data source and that includes indicator values from evaluations of at least one of the indicators, at least one of the indicator values that was determined at a time before the change was made. The indicator value is identified as having been determined using the data value. The method includes modifying the identified indicator value in the history repository using at least the change of the data value.

### TECHNICAL FIELD

This document relates to managing indicator values.

### BACKGROUND

Businesses can use combinations of computer hardware and software to manage information. Often the information can be presented to employees or members of an organization. The information gathered about a business can often provide an outlook on how the business is performing relative to some benchmark. The company's performance can facilitate change within an organization, such as a reduction in workforce to reduce expenses and reach a level of profitability.

Many businesses or organizations track performance based on indicators, such as key performance indicators (KPIs). KPIs can be used by companies involved in manufacturing or selling goods, or in providing services, to name just a few examples. In business, KPIs can relate to many different topics, such as revenue, profits and capacity. KPIs can be evaluated for certain key figures over various time intervals, such as year-to-date net income and previous calendar year net profit, to name two examples. Such evaluations can involve making time dependent selections in a repository of business information. A system can be configured to present performance information in a variety of ways. For example, when a KPI is evaluated, the result can be output to a user, which gives the user an understanding of that aspect of the company's business.

### SUMMARY

The invention relates to managing indicator values.

In a first aspect, a computer-implemented method for managing indicator values includes identifying a change that has been made in a data source to a data value relating to a specific date. Multiple indicators have been defined that can be evaluated using business information in the data source. The method includes identifying, in a history repository that is separate from the data source and that includes indicator values from evaluations of at least one of the indicators, at least one of the indicator values that was determined at a time before the change was made. The indicator value is identified as having been determined using the data value. The method includes modifying the identified indicator value in the history repository using at least the change of the data value.

Implementations can include any, all or none of the following features. The indicator can include a key performance indicator defined as a quantifiable factor of business performance, the identified indicator value reflecting the business performance. The method can further include determining a new value for the indicator using at least some of the business information, wherein the change is identified in response to determining the new value. The data source can be configured so that changes to any of the business information are entered as postings in the data source, each posting comprising: (i) a date that the posting is made; (ii) identification of a portion of the business information that the change applies to; and (iii) a date of the portion of the business information. The method can further include identifying the posting in the data source; accessing, in the data source, the date that the posting is made; accessing, in the history repository, a most recent date that the indicator was evaluated; and comparing the date that the posting is made with the most recent date. The identified indicator value can be modified upon determining that the date that the posting is made, but not the date of the portion of the business information, is after the most recent date. Identifying the indicator value can include performing a query in the history repository, the query not identifying any time interval that was specified in generating the indicator values. The query can specify: an indicator identifier, an evaluation identifier, and a date specification. The evaluation identifier can specify user-dependent settings that were taken into account in determining at least one of the indicator values.

In a second aspect, a computer program product is tangibly embodied in a computer-readable storage medium and includes instructions that when executed by a processor perform a method for managing indicator values. The method includes identifying a change that has been made in a data source to a data value relating to a specific date, wherein multiple indicators have been defined that can be evaluated using business information in the data source. The method includes identifying, in a history repository that is separate from the data source and that includes indicator values from evaluations of at least one of the indicators, at least one of the indicator values that was determined at a time before the change was made, the indicator value identified as having been determined using the data value. The method includes modifying the identified indicator value in the history repository using at least the change of the data value.

Implementations can include any, all or none of the following features. The method can further include determining a new value for the indicator using at least some of the business information, wherein the change is identified in response to determining the new value. The data source can be configured so that changes to any of the business information are entered as postings in the data source, each posting comprising: (i) a date that the posting is made; (ii) identification of a portion of the business information that the change applies to; and (iii) a date of the portion of the business information. The method can further include identifying the posting in the data source; accessing, in the data source, the date that the posting is made; accessing, in the history repository, a most recent date that the indicator was evaluated; and comparing the date that the posting is made with the most recent date. The identified indicator value can be modified upon determining that the date that the posting is made is after the most recent date. Identifying the indicator value can include performing a query in the history repository, the query not identifying any time interval that was specified in generating the indicator values. The query can specify: an indicator identifier, an evaluation identifier, and a date specification. The evaluation identifier can specify user-dependent settings that were taken into account in determining at least one of the indicator values.

In a third aspect, a repository for managing indicator values is tangibly embodied in a computer-readable storage medium and includes indicator values from evaluations of at least one of multiple indicators defined for evaluation using business information in a data source that is separate from the repository. The repository is configured such that any of the indicator values that was determined using a particular data value in the data source can be identified in the repository as having been determined at a time before a change was made to the data value. The repository is also configured such that the identified indicator value can be modified in the repository using at least the change of the data value.

Implementations can include any, all or none of the following features. The repository can be configured to have performed therein, and provide results to, a query for at least one of the indicator values, the query not identifying any time interval that was specified in generating the indicator values. The query can specify, and each of the indicator values can be associated with: an indicator identifier, an evaluation identifier, and a date specification. The evaluation identifier can specify user-dependent settings that were taken into account in determining at least one of the indicator values. Each of the indicator values can include at least a target value and an actual value associated with the target value.

Implementations can provide any, all or none of the following advantages. An efficient record of performed indicator evaluations can be provided. Convenient updating of previously calculated indicator values can be provided. Previously calculated indicator values that are affected by a change in business data can be identified without making a complex selection in business data.

The details of one or more embodiments are set forth in the accompanying drawings and the description below. Other features and advantages will be apparent from the description and drawings, and from the claims.

### DESCRIPTION OF DRAWINGS

FIG. 1 is a block diagram showing an example of a system for managing and using performance history information.

FIG. 2 is an example timeline showing an evaluation schedule.

FIG. 3 is a flowchart showing an example of a process for managing performance history information.

FIG. 4 is a block diagram of a computing system that can be used in connection with computer-implemented methods described in this document.

Like reference symbols in the various drawings indicate like elements.

### DETAILED DESCRIPTION

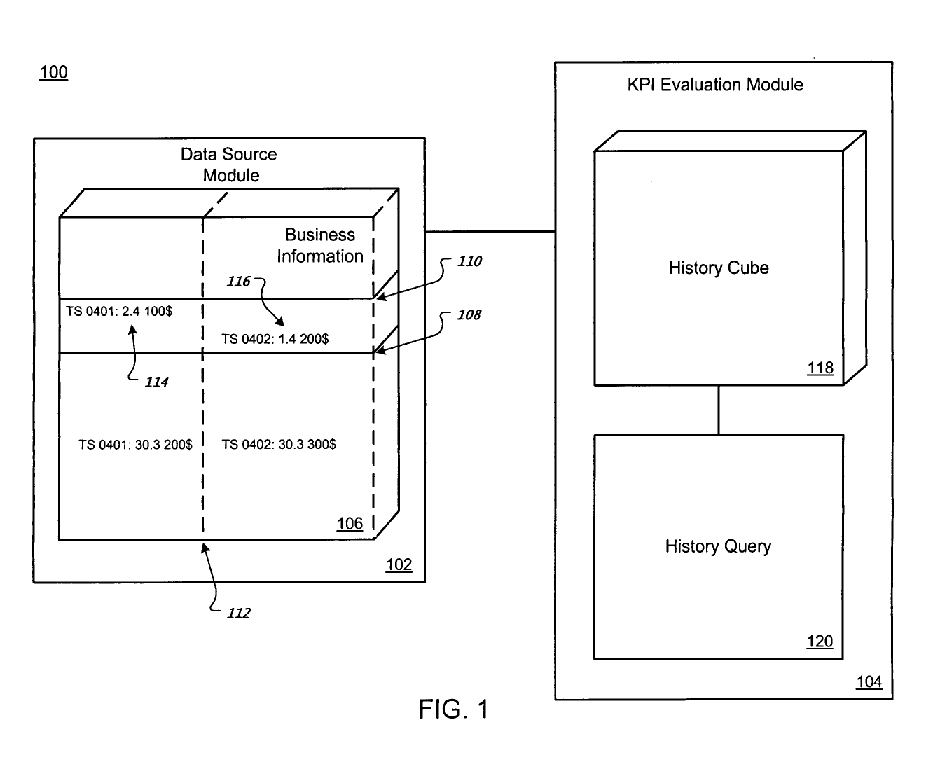

FIG. 1 is a block diagram showing an example of a system 100 for managing and using history information relating to one or more indicators. The system 100 can include a data source module 102 and a KPI evaluation module 104, to name two examples. The data source module 102 can be configured to manage business information 106. Examples of business information 106 include sales information, revenue information, other types of information, or combinations thereof. Such data is sometimes referred to as transactional data and can, for example, be generated by a computer system used by a sales organization.

In some implementations, the business information can be stored and managed in more than one dimension, such as in a data cube. The data can be maintained by a data warehouse or another data management system. A data cube can include a multi-dimensional array of data, where data and arrays of data can be treated as single entities distinct from their contents. A data warehouse can be a repository of data for an organization, capable of receiving and executing complex queries and performing analysis.

The system 100 can include the KPI evaluation module 104 for managing evaluations of one or more indicators. Indicators can include key figures defined to reflect business-relevant aspects of an organization's financial information. One example of a key figure is a KPI (Key Performance Indicator). A KPI can be defined as a quantifiable measure of certain performance aspects of business processes or organizations. KPIs may be used to assess the present state of a business and optionally to prescribe a course of action. Evaluations of KPIs can produce one or more numbers or other quantitative information that can be the main entities visible to users working with KPIs. In some implementations, the evaluations can be defined in terms of selection conditions. For example, selection conditions can include input parameters such as country, and time period (e.g.; year-to-date).

In the example implementation shown in FIG. 1, the business information 106 can be stored as a multi-dimensional set of data, including: a first dimension defined as a time dependent selection; a second dimension here defined as sales data; and a third dimension defined as the time stamp for when a change is posted to the stored data. In some implementations, a time dependent selection can be described as a definition of a time that data relates to, for example, “a toaster was sold for $200 on 04/01”. The time stamp for when a change is posted to the stored data can be defined, for example, as “the price for the sold toaster was changed from $200 to $300 on 04/03”. These multi-dimensional sets of data can include many other dimensions and aspects. In some implementations, the business sales information example shown in FIG. 1 may have additional dimensions for company, product, sales organization, and customer, to name a few examples. In some implementations, the business information 106 can include one or more Infocubes, a term used for a feature in products from SAP AG.

In the example implementation shown in FIG. 1, the KPI evaluation module 104 may evaluate some or all of business information 106 from an evaluation start point 108 to an evaluation end point 110, the evaluation performed at a given point in time 112. The start point 108 and end point 110 may be defined as part of the evaluation definition. Based on the definition of the evaluation, postings or changes made to business information 106 may be included as part of the evaluation. Postings can include information such as a posting date, an effective date, a financial change to business information, other information, or combinations thereof. Postings can be stored and managed within the business information 106, and the business information 106 can be accessed to determine the date a posting is entered. In order to determine whether a posting can be included in an evaluation, the history cube 118 can be accessed to determine if the posting is effective before the most recent evaluation date. For example, a posting 114, shown in FIG. 1 as “TS 0401: 2.4 100$” can be interpreted as: a posting date of April 2^{nd} (e.g.; 2.4), an effective date of April 1^{st} (e.g.; 0401), and an entered value of $100 (e.g.; 100$) to one or more pieces of business information 106. Any posting can represent a new data value or a change of an existing data value. The posting “TS 0401: 2.4 100$” is shown to have a timestamp prior to the example point in time 112. In this example, the time 112 can be defined as April 2nd, 8:00 AM. Because the evaluation is defined using the point in time 112, the posting 114 and its associated change to business information (e.g.; 100$) can be effective before the evaluation is being made and thus can be included in the evaluation. A posting 116, shown in FIG. 1 as “TS 0402: 1.4 200$” is shown to have a timestamp after the point in time 112. Because the evaluation is performed at the point in time 112, the posting 116 and its associated change to business information (e.g.; 100$) did not exist at the time of the evaluation; rather, the posting may be included in an evaluation performed at a time after the point in time 112.

In some implementations, views of KPIs can be personalized. This means that the definition of how the KPI is calculated and/or the data it is applied to and/or how the result is presented is tailored to the individual user. The KPI evaluation module 104 can provide personalized views of KPIs, including filtering, aggregation, and a comparison with a reference value, to name a few examples. This means that the KPI evaluation module 104 can access the parameters of a KPI in order to perform one or more evaluations based on the KPI's attributes. For example, the KPI can include a default schedule attribute, including: daily; weekly; monthly; yearly, or some other schedule attribute. This schedule attribute can influence how often KPIs are evaluated. In some implementations, the KPI evaluation module 104 can include a software application managed by another system. In other implementations, the KPI evaluation module 104 can include, or have communications with, a graphical user interface used to manage KPI evaluations. The KPI evaluation module can include a history cube 118 and one or more history queries 120. The history cube 118 can be used for storing evaluation information, including actual and target values, to name two examples. To provide efficient retrieval of KPI history during an evaluation, the history cube 118 can be filled and modified whenever a KPI is evaluated. The history cube can be formed by any of many different data structures, including a multidimensional structure such as an InfoCube available in products from SAP AG Example information contained in the history cube 118 can include a KPI identifier, a KPI evaluation identifier, and a calculation time. The history query 120 can be performed to select values from the history cube 118. The history query 120 may be configured to let users formulate queries and/or to accept queries from other systems. The history query 120 can include one or more search parameters including: an indicator identifier; an evaluation identifier; and a date specification. In some implementations, a general and/or universal query can be included in the history query 120.

The KPI evaluation module 104 can provide information to the history cube 118 in various ways. In some implementations, the KPI evaluation module 104 can update the history cube 118 with values or status information. Values can include single calculated values for evaluations comparing, for example, current values to a budget plan value. Other examples of information store in the history cube 118 can include the results of any evaluation, including evaluations of reference values, status evaluations, timeliness, validity dates, and trend figures. Status information can include information expressed as multiple values. For example, status information may include a status indicator of “below plan”, and additionally include the information causing the indicator to have a value below plan, such as revenue “below plan” for one or more time periods within the specified evaluation period. In other implementations, KPI evaluation module 104 can store changes to an evaluation once an evaluation is performed.

In some implementations, KPI evaluations that include comparisons to one or more KPI values obtained earlier can be displayed using a graphical user interface, or provided to another system. Such a comparison can involve an actual KPI value and a target KPI value, to name just one example. Personalizing evaluation parameters can provide an efficient method for comparing evaluations by filtering the evaluation to include the information desired by the user or system. In some implementations, evaluations can be based on complex and personalized user settings, and may include reference values (from prior evaluations). Accordingly, an evaluation identifier included in the history query 120 can specify one or more user-dependent settings that were taken into account in determining value(s). Storing an evaluation history in the history cube 118 that includes the KPI values obtained at one or more earlier evaluations can avoid the need for creating individual queries for each evaluation.

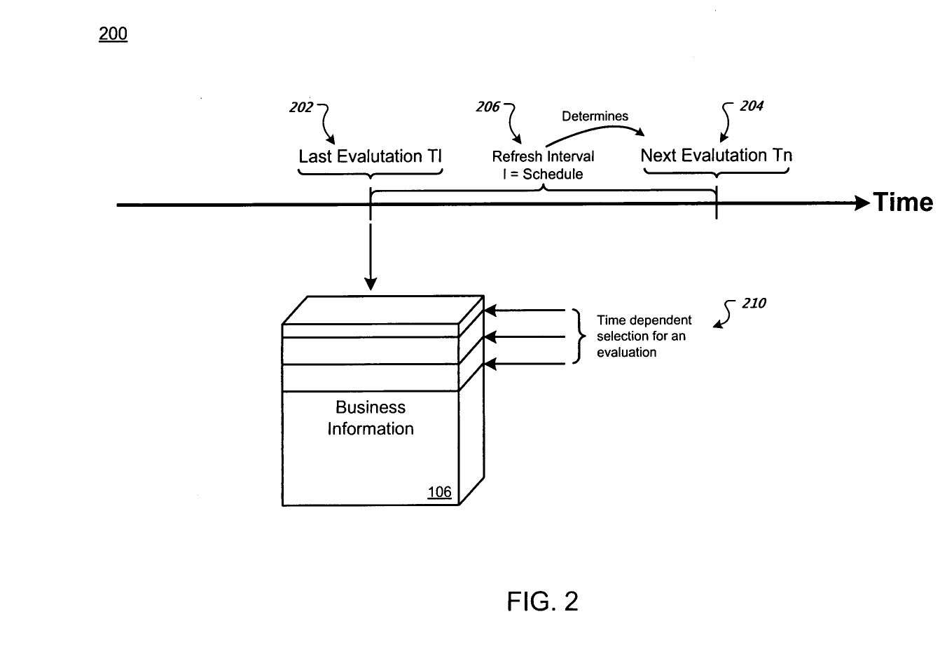

FIG. 2 is an example timeline 200 schematically showing an evaluation schedule. In the example, timing attributes of an evaluation are depicted as a last evaluation time 202, a next evaluation time 204, and a refresh schedule interval 206. The last evaluation time 202 here represents the last time in which a KPI was evaluated by accessing the business information 106. The refresh schedule interval 206 can be used, in this example implementation, to determine the value of the next evaluation time 204. The next evaluation time here represents the next time that this particular KPI is scheduled to be evaluated. The refresh schedules for evaluations can be managed by the KPI evaluation module 104 described previously for FIG. 1.

In other implementations, the schedule 206 and/or the next evaluation time 204 for an evaluation may be managed by a user using a graphical user interface. For example, a user may wish to calculate an evaluation at a time earlier or later than the next scheduled evaluation time 204.

As depicted in FIG. 2, at the time of the last evaluation 202, the business information 106 (FIG. 1) can be accessed to determine the value of the indicator (described previously for FIG. 1) used in the evaluation. The evaluation performed at the last evaluation time 202 can include, in its definition, starting and ending date/time ranges as described previously for FIG. 1. The information stored in the business information 106 can be accessed using one or more time dependent selections 210. Time dependent selections 210 can include complex calculations of, for example: time, day, month, or year. These complex calculations can assist to define the beginning and ending of a selection of information used for evaluation. In contrast, the history query 120 that can be performed in the history cube 118 need not specify such a complex time dependent selection. Accordingly, the history query 120 can be formulated much simpler than a search in the business information 106.

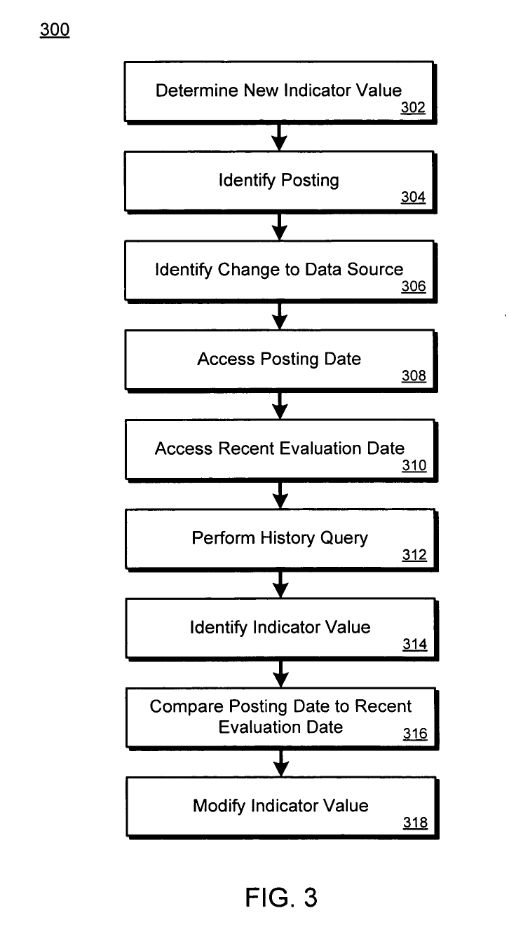

FIG. 3 is a flowchart showing an example of a process 300 for managing history information. For example, the process 300 can be performed by a processor, executing instructions stored in a computer-readable storage medium. The process 300 begins by determining a new indicator value at step 302. For example, a new KPI value can be calculated based on the scheduled next evaluation 204, and this calculation can take into account a posting modifying information in the data source that applies to data covered by the indicator. Indicator values may be managed or stored by the KPI evaluation module 104, described earlier for FIG. 1. The KPI evaluation module 104 can communicate with the data source module 102 to access business information 106.

Based on the description of the indicator, postings (e.g.; postings 114 and 116, FIG. 1) are identified at step 304 that may affect the value or status of one or more performed evaluations of the indicator. Postings that may affect the value or status of the indicator can include postings with a specified effective date and time earlier than the date and time of the last evaluation date and time, as described for the timeline 200, FIG. 2. The data source module 102 (FIG. 2) can receive postings to modify business information 106 (FIG. 2) received from various communicating systems. These postings can affect the values of the business information 106 (FIG. 2). The postings can include a posting date, an effective date, a financial value, and other information.

At step 306, changes to information in data sources can be identified. For example, identifying changes to data sources can include reading one or more financial figures from the postings 114 (e.g.; 100$) and/or 116 (e.g.; 200$). The example financial figures shown in the postings 114 and 116 can be stored, for example, as a field in a database entry, where the remaining elements of the posting, such as the posting time and effective time, are other fields in a database. At step 308, the dates of the postings can be accessed. For example, the data source module 102 (FIG. 1) can include a function or application to read and parse the dates of postings (depicted in FIG. 1 as postings 114 and 116) stored in the business information 106 (FIG. 1). At step 310, the history cube 118 can be accessed to retrieve the most recent date an evaluation was performed. The posting dates accessed in step 308 can be compared to the most recent evaluation date in step 310. Postings with a posting date after the most recent evaluation date accessed in step 310, and an effective date earlier than the most recent evaluation date can be included for modification of business information.

At step 312, a history query can be performed. Performing a history query can retrieve information from one or more history cubes 118, or other information sources managed by the KPI evaluation module 104. For example, the history query 120 (FIG. 1) can query the history cube 118 (FIG. 1) using an indicator identifier, an evaluation identifier, and a date specification. The evaluation identifier can include information to identify the user performing the evaluation, and in some implementations use the information to transmit the customized results of an evaluation to a graphical user interface. For example, the history query 120 can format its queries as SQL database queries. The KPI evaluation module 104 can manage these queries, and may use the queries to retrieve information from the history cube 118. At step 314, the history cube 118 may be accessed to identify and retrieve the indicator values during an evaluation managed by the KPI evaluation module 104.

At step 316, the dates of postings are compared to the date of the most recent evaluation. This can, for example, identify one or more performed evaluations as being affected by the posting. Such evaluation (s) can then be performed anew, taking the data of the posting into account. Accordingly, one or more new indicator values can be obtained. At step 318, indicator values are modified in the history cube 118. The data source module 102 (FIG. 1) manages communication with other modules, including the KPI evaluation module 104 (FIG. 1). As evaluations are performed by the KPI evaluation module 104, the new indicator results are stored with the evaluation in the history cube 118.

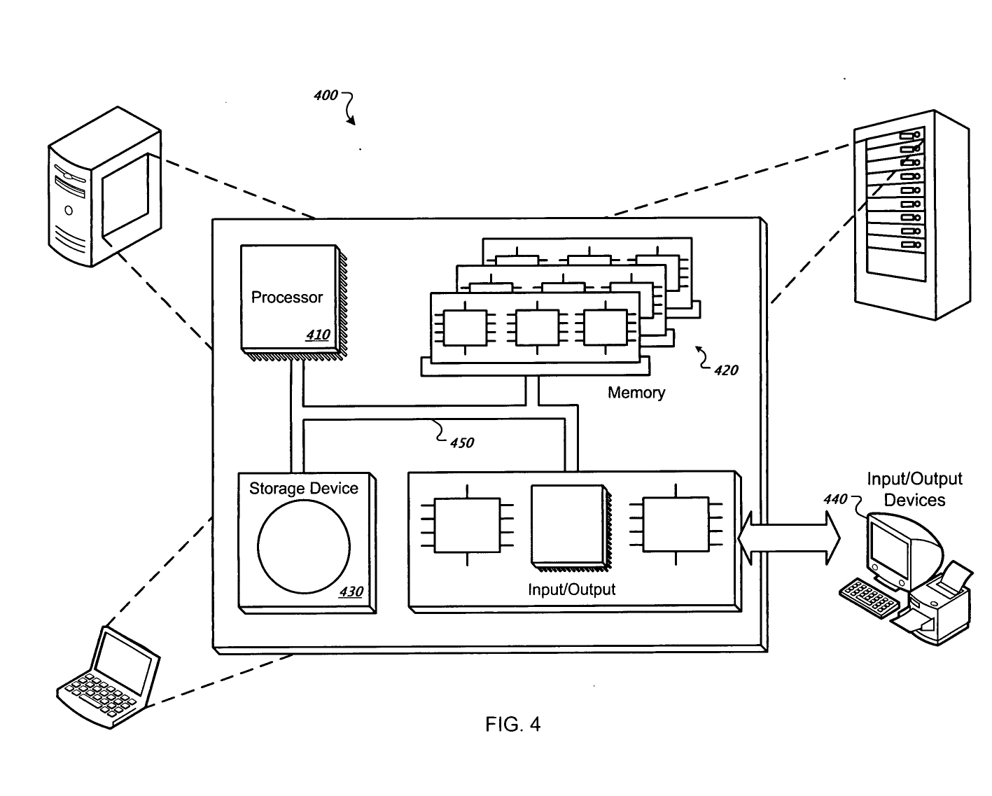

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for managing indicator values, the method comprising:
identifying a change that has been made in a data source to a data value relating to a specific date, wherein multiple indicators have been defined that can be evaluated using business information in the data source;
identifying, in a history repository that is separate from the data source and that includes indicator values from evaluations of at least one of the indicators, at least one of the indicator values that was determined at a time before the change was made, the indicator value identified as having been determined using the data value; and
modifying the identified indicator value in the history repository using at least the change of the data value.

2. The computer-implemented method of claim 1, wherein the indicator comprises a key performance indicator defined as a quantifiable factor of business performance, the identified indicator value reflecting the business performance.

3. The computer-implemented method of claim 1, further comprising:
determining a new value for the indicator using at least some of the business information, wherein the change is identified in response to determining the new value.

4. The computer-implemented method of claim 1, wherein the data source is configured so that changes to any of the business information are entered as postings in the data source, each posting comprising: (i) a date that the posting is made; (ii) identification of a portion of the business information that the change applies to; and (iii) a date of the portion of the business information.

5. The computer-implemented method of claim 4, further comprising:
identifying the posting in the data source;
accessing, in the data source, the date that the posting is made;
accessing, in the history repository, a most recent date that the indicator was evaluated; and
comparing the date that the posting is made with the most recent date;
wherein the identified indicator value is modified upon determining that the date that the posting is made, but not the date of the portion of the business information, is after the most recent date.

6. The computer-implemented method of claim 1, wherein identifying the indicator value comprises:
performing a query in the history repository, the query not identifying any time interval that was specified in generating the indicator values.

7. The computer-implemented method of claim 6, wherein the query specifies: an indicator identifier, an evaluation identifier, and a date specification.

8. The computer-implemented method of claim 7, wherein the evaluation identifier specifies user-dependent settings that were taken into account in determining at least one of the indicator values.

9. A computer program product tangibly embodied in a computer-readable storage medium and comprising instructions that when executed by a processor perform a method for managing indicator values, the method comprising:
identifying a change that has been made in a data source to a data value relating to a specific date, wherein multiple indicators have been defined that can be evaluated using business information in the data source;
identifying, in a history repository that is separate from the data source and that includes indicator values from evaluations of at least one of the indicators, at least one of the indicator values that was determined at a time before the change was made, the indicator value identified as having been determined using the data value; and
modifying the identified indicator value in the history repository using at least the change of the data value.

10. The computer program product of claim 9, further comprising:
determining a new value for the indicator using at least some of the business information, wherein the change is identified in response to determining the new value.

11. The computer program product of claim 9, wherein the data source is configured so that changes to any of the business information are entered as postings in the data source, each posting comprising: (i) a date that the posting is made; (ii) identification of a portion of the business information that the change applies to; and (iii) a date of the portion of the business information.

12. The computer program product of claim 11, wherein the method further comprises:
identifying the posting in the data source;
accessing, in the data source, the date that the posting is made;
accessing, in the history repository, a most recent date that the indicator was evaluated; and
comparing the date that the posting is made with the most recent date;
wherein the identified indicator value modified upon determining that the date that the posting is made is after the most recent date.

13. The computer program product of claim 9, wherein identifying the indicator value comprises:
performing a query in the history repository, the query not identifying any time interval that was specified in generating the indicator values.

14. The computer program product of claim 13, wherein the query specifies: an indicator identifier, an evaluation identifier, and a date specification.

15. The computer program product of claim 14, wherein the evaluation identifier specifies user-dependent settings that were taken into account in determining at least one of the indicator values.

16. A repository for managing indicator values, the repository tangibly embodied in a computer-readable storage medium and comprising:
indicator values from evaluations of at least one of multiple indicators defined for evaluation using business information in a data source that is separate from the repository, the repository configured such that any of the indicator values that was determined using a particular data value in the data source can be identified in the repository as having been determined at a time before a change was made to the data value, the repository also configured such that the identified indicator value can be modified in the repository using at least the change of the data value.

17. The repository of claim 16, wherein the repository is configured to have performed therein, and provide results to, a query for at least one of the indicator values, the query not identifying any time interval that was specified in generating the indicator values.

18. The repository of claim 17, wherein the query specifies, and wherein each of the indicator values is associated with: an indicator identifier, an evaluation identifier, and a date specification.

19. The repository of claim 18, wherein the evaluation identifier specifies user-dependent settings that were taken into account in determining at least one of the indicator values.

20. The repository of claim 16, wherein each of the indicator values comprises at least a target value and an actual value associated with the target value.
